(19) United States
(12) Patent Application Publication
(10) Pub. No.: US 2006/0156016 A1
(43) Pub. Date: Jul. 13, 2006

(54) Session start method, icon image creation device, session startg program, and icon image creation program

(76) Inventor: Shojiro Tanaka, SHIMANE (JP)

Correspondence Address: MCDERMOTT WILL & EMERY LLP, 600 13TH STREET, N.W., WASHINGTON, DC, 20005-3096, US

(21) Appl. No.: 10/523,410

(22) PCT Filed: Feb. 12, 2004
(86) PCT No.: PCT/JP04/01446

§ 371 Date: Feb. 3, 2005

(30) Foreign Application Priority Data
Feb. 12, 2003 (JP) 2003-034322

(51) Int. Cl. H04L 9/00

(52) U.S. Cl. 713/182

(57) ABSTRACT

A session initiating method includes specifying an icon image corresponding to a user; determining whether start information is embedded in the icon image; extracting the start information from the icon image based on an algorithm that is unique to the user when it is determined that the start information is embedded in the icon image; setting-up the session; inputting the start information during the session; verifying whether the start information input at the inputting satisfies a condition for initiating the session; and controlling the session based on a result of the verifying. When it is verified that the start information satisfies the condition, the controlling includes initiating the session, and when it is not verified that the start information satisfies the condition, the controlling includes aborting the session.

### TECHNICAL FIELD

The present invention relates to a session initiating method, an icon-image creating apparatus, a session initiating program, and an icon-image creating program and, more particularly, to a session initiating method, an icon-image creating apparatus, a session initiating program, and an icon-image creating program that are applied to or used in a computer system equipped with a GUI.

### BACKGROUND ART

Conventionally, a user ID and a password are sometimes required for a session, that is, a process to connect to another computer, such as log-in and log-on, or for a process to start an application. Introduction of the user ID and the password enable to prevent unauthorized access. Prevention of the unauthorized access includes prevention of unauthorized access by an outsider, and prevention of unnecessary access to a confidential part, providing a hierarchically structure, by a user that is permitted to access.

Conventionally, the user ID and the password are used for construction and operation of a secure system.

However, there are problems described below in the conventional technology.

The user ID and the password are merely meaningless and elusive character strings, and inputting such character strings with a keyboard at each initiation of the session is very burdensome to users. For this reason, users sometimes put a piece of paper on which the user ID and the password are noted near the computer. As a result, the computer system eventually becomes an insecure computer system practically.

Furthermore, such meaningless character strings are difficult to be managed by users, and therefore, the password is frequently lost. This causes an extra work for a system administrator to reissue the password, interferes with a management work, which is an original task of the system administrator.

Some users feel uncomfortable to be held under management of the system administrator. In other words, sometimes it is desirable to provide a system that does not make the users recognize presence of the system administrator depending on a use. On the contrary, sometimes it is desirable to provide a system in which a limit is set to access without being recognized by the users.

Moreover, in a recent trend toward equipping with a GUI in many electronic appliances, it is also undesirable to force users to input character-based complicated character strings against the trend.

Accordingly, it is an object of the present invention to provide a computer system with increased security, that relieves the users of inputting character-based complicated start information, and that enables the system administrator to manage the system without letting the users recognize the start information.

Another object of the present invention is to construct a highly convenient computer system while relieving the users of management of the character-based complicated start information.

### DISCLOSURE OF THE INVENTION

A session initiating method according to the present invention is applied to a computer system equipped with a graphical user interface (GUI), and includes specifying an icon image that corresponds to each of user; determining embedded information to determine whether start information that is necessary for initiating a session that is predetermined is embedded in the icon image specified in the image specifying; extracting the start information from the icon image in accordance with an algorithm that uniquely corresponds to each of the user when it is determined that the start information is embedded in the icon image in the determining; setting up the session; inputting, during the session that is set up in the setting up, the start information extracted in the extracting; verifying whether the start information input in the inputting meets a condition for initiating the session; and controlling the session to initiate the session if it is determined, in the verifying, that the start information meets the condition, and to discontinue setting up the session if it is determined, in the verifying, that the start information does not meet the condition.

Therefore, it is possible to initiate a session by manipulating an icon that includes start information embedded that is essentially indecipherable cipher set for each of users. The initiation of a session is to make a desirable state of the user, and the setting up the session is execution of an initial process of a program or components (static link library or dynamic link library) at the initiation of the session.

According to the present invention, in the session initiating method described above, the start information includes a user ID and a password of the user.

Therefore, the initiation of the session is possible even if the user does not remember his/her user ID and password.

An icon-image creating apparatus according to the present invention creates an icon image to initiate the session described above, and includes an image-information inputting unit that inputs icon image information that corresponds to each of users; a user-information inputting unit that inputs user information that is assigned to each of the users; an area detecting unit that detects an area in which additional information can be embedded without altering the icon image, according to a structure of the icon image information input by the image-information inputting unit; an area determining unit that determines the area in which the user information, which is input by the user information inputting unit, is to be embedded, from the areas detected by the area detecting unit, in accordance with an algorithm that uniquely corresponds to each of the users; an information embedding unit that embeds the user information in the area determined by the area determining unit; and an icon-image outputting unit that outputs the icon image in which the user information is embedded by the information embedding unit.

Therefore, it is possible to embed user information as an essentially indecipherable cipher in the icon image that is easily identified by the user.

According to the present invention, in the icon-image creating apparatus described above, the user information includes a user ID and a password that is necessary for initiating the session.

Therefore, the initiation of the session is possible even if the user does not remember his/her user ID and password.

A computer program for initiating a session according to the present invention is applied to a computer system equipped with a GUI, and makes a computer function as an image specifying unit, an embedded-information determining unit, an information extracting unit, a session setting-up unit, an information input unit, a verification unit, and a session controlling unit, and makes the computer execute specifying an icon image that corresponds to each of user; determining embedded information to determine whether start information that is necessary for initiating a session that is predetermined is embedded in the icon image specified in the image specifying; extracting the start information from the icon image in accordance with an algorithm that uniquely corresponds to each of the user when it is determined that the start information is embedded in the icon image in the determining; setting up the session; inputting, during the session that is set up in the setting up, the start information extracted in the extracting; verifying whether the start information input in the inputting meets a condition for initiating the session; and controlling the session to initiate the session if it is determined, in the verifying, that the start information meets the condition, and to discontinue setting up the session if it is determined, in the verifying, that the start information does not meet the condition.

Therefore, it is possible to initiate the session by manipulating the icon that includes the essentially indecipherable start information set for each of the user.

According to the present invention, in the computer program for initiating a session described above, the start information includes a user ID and a password of the user.

Therefore, the initiation of the session is possible even if the user does not remember his/her user ID and password.

A computer program for creating an icon-image to initiate the session according to the present invention makes a computer function as an image-information inputting unit, a user-information inputting unit, an area detecting unit, an area determining unit, an information embedding unit, and makes the computer execute inputting icon image information that corresponds to each of users; inputting user information that is assigned to each of the users; detecting an area in which additional information can be embedded without altering the icon image, according to a structure of the icon image information input by the image-information inputting unit; determining the area in which the user information, which is input by the user information inputting unit, is to be embedded, from the areas detected by the area detecting unit, in accordance with an algorithm that uniquely corresponds to each of the users; embedding the user information in the area determined by the area determining unit; and outputting the icon image in which the user information is embedded by the information embedding unit.

Therefore, it is possible to embed user information as an essentially indecipherable cipher in the icon image that is easily identified by the user.

According to the present invention, in the computer program for creating an icon-image described above, the user information includes a user ID and a password that is necessary for initiating the session.

Therefore, the initiation of the session is possible even if the user does not remember his/her user ID and password.

### BRIEF DESCRIPTION OF THE DRAWINGS

FIG. 1 is a schematic of an example of a configuration of a computer system to which a session initiating method according to the present invention is applied;

FIG. 2 is a block diagram of an example of a hardware configuration of a server device;

FIG. 3 a block diagram of an example of a hardware configuration of a client device;

FIG. 4 is a block diagram of an example of a functional configuration of the computer system;

FIG. 5 is a flowchart of an example of a process by the computer system;

FIG. 6 is a schematic of an example of a display to request for a log-in process;

FIG. 7 is a schematic of an example of a display for inputting a user ID and a password on a client device;

FIG. 8 is a schematic of an example of a display that is displayed on the screen when drag and drop of the icon image is just carried out;

FIG. 9 is a schematic of a display that is displayed on a monitor of the client device when log-in is established;

FIG. 10 is a block diagram of an example of a hardware configuration of an icon-image creating apparatus;

FIG. 11 is a block diagram of an example of a functional configuration of the icon-image creating apparatus;

FIG. 12 is a flowchart of an example of a process by the-icon-image creating apparatus;

FIG. 13 is a schematic of an example of a display that is displayed when a process program is started;

FIG. 14 is a diagram of an example of a display that is displayed after the icon image is specified;

FIG. 15 is a schematic of an example of a window display that instructs to input the password; and

FIG. 16 is a schematic of a window display after an embedding process is performed.

### BEST MODE FOR CARRYING OUT THE INVENTION

The present invention will be explained below in detail with reference to the accompanying drawings.

### First Embodiment

A computer system to which a session initiating method according to the present invention is applied will be explained in a first embodiment.

(Configuration Outline of Computer System to which Session Initiating Method is Applied)

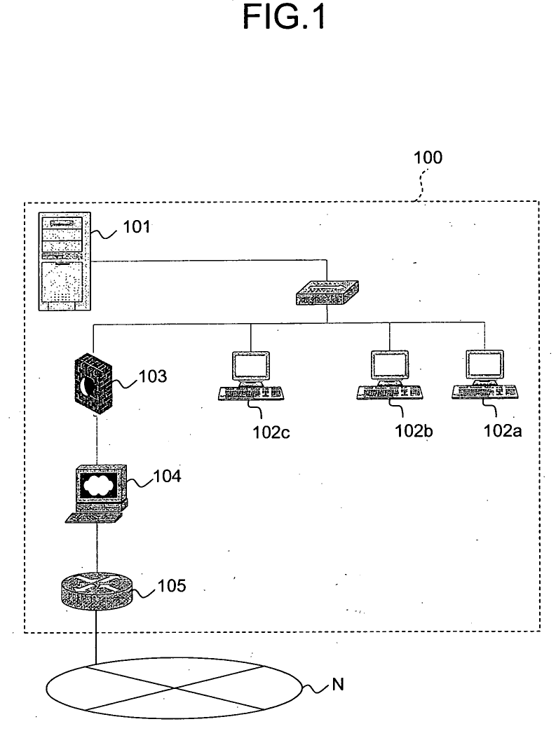

FIG. 1 is a schematic of an example of a configuration of the computer system to which the session initiating method according to the present invention is applied. A computer system 100 includes a server device 101 and a client device 102 (client devices 102a, 102b, . . . 102c) as main components.

In the present invention, a session refers to a process to connect to another computer, such as log-in or log-on, and a process to start an application, but the first embodiment will focus on a log-in process for logging in the server device 101 from the client device 102. An outline of the process is that a user starts an application for connecting to the server device 101 on the client device 102, then drags an icon image, which is prepared for the user for connection, on a window of the application, and logs in the server device 101, if valid start information is included in the icon image. The start information is information necessary for the log-in, which is a user ID and a password that are embedded in the icon image corresponding to each of the user. While the log-in process will be described using the user ID and the password as the start information, the start information is not limited to the user ID and the password, and may be any information for starting the log-in process, such as the icon image itself.

As shown in FIG. 1, the computer system 100 further includes a fire wall 103, an Internet server 104, and a router 105. These components are arranged to connect the computer system 100 to the Internet N, and to prevent unauthorized access through the Internet N at the same time. Depending on a use, the fire wall 103 may includes a function of supervising to prevent the icon image from leaking outside of an intranet, that is, to the Internet N. Moreover, the icon image may include a function of dropping off the start information contained therein when the icon image is copied.

(Hardware Configuration of Server Device 101)

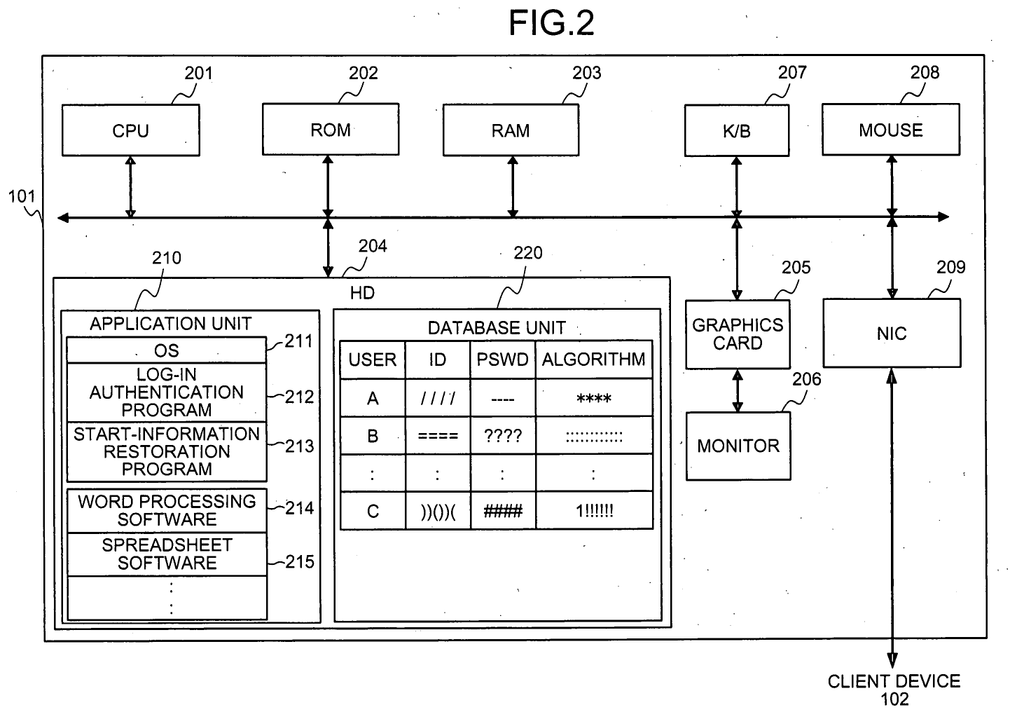

A hardware configuration of the server device 101 will be described below. FIG. 2 is a block diagram of an example of the hardware configuration of the server device 101. The server device 101 includes a central processing unit (CPU) 201, a read only memory (ROM) 202, a random access memory (RAM) 203, a hard disk (HD) 204, a graphics card 205, a monitor 206, a keyboard (K/B) 207, a mouse (MOUSE) 208, and a network interface card (NIC) 209.

The CPU 201 controls whole the server device 101 together with an operating system (OS), and controls processes of various kinds of software, including process for a log-in request from the client device 102. Specifically, for example, the CPU 201 determines whether a user is registered, and whether the password matches with a password stored, in response to the log-in request from the client device 102 according to a program stored in the hard disk 204 or the ROM 202. The CPU 201 controls drawing for a VRAM of the graphics card 205, and controls to temporarily store, in the RAM 203, work data stored in the hard disk 204.

The ROM 202 stores a boot program and the like. Depending on a use, the ROM 202 may store a control program of the server device 101. The RAM 203 is used as a work area of the CPU 201. More specifically, the RAM 203 temporarily stores various kinds of programs including a log-in processing program read from the hard disk 204 and the start information described above. The RAM 203 also stores an algorithm for extracting or restoring the start information from the icon image.

The hard disk 204 stores various kinds of software programs such as an operating system (OS), an application program, and a driver. A configuration of the hard disk will be described later.

The graphics card 205 sends an image signal to be output to the monitor 206. The graphics card 205 includes a VRAM that stores the image signal to be output, and an image output interface (image output I/F) that outputs the image signal processed to the monitor 206. The image output I/F outputs RGB image data loaded into the VRAM to the monitor 206.

The NIC 209 connects the server device 101 to the intranet. The intranet mentioned herein is the computer system 100 with the server device 101 and the client device 102 networked together. The start information is input to the server device 101 through the NIC 209, enabling the server device 101 to determine whether to permit or prohibit the log-in.

The server device 101 may also includes a flexible disk driver, a CD-ROM driver, a MO driver, and the like.

The hard disk 204 includes an application unit 210 and a database unit 220. The application unit 210 includes an OS 211 that controls an entire operation of the server device 101, a login authentication program 212 that determines whether to permit or prohibit the log-in, and a start-information restoration program 213 that extracts the start information from the icon image. The application unit 210 further stores word processing software 214, spreadsheet software 215, and various other kinds of software.

The database unit 220 stores the user ID and the password paired with each other for each of the users. The server device 101 extracts the user ID from the icon image transmitted from the client device 102, then checks whether the user ID extracted is an ID registered in the database unit 220. If the user ID extracted is the ID registered, the server device 101 determines whether the password is valid. The database unit 220 also stores an extraction algorithm as well as the user ID and the passwords. The algorithm is explained later.

(Hardware Configuration of Client Device 102)

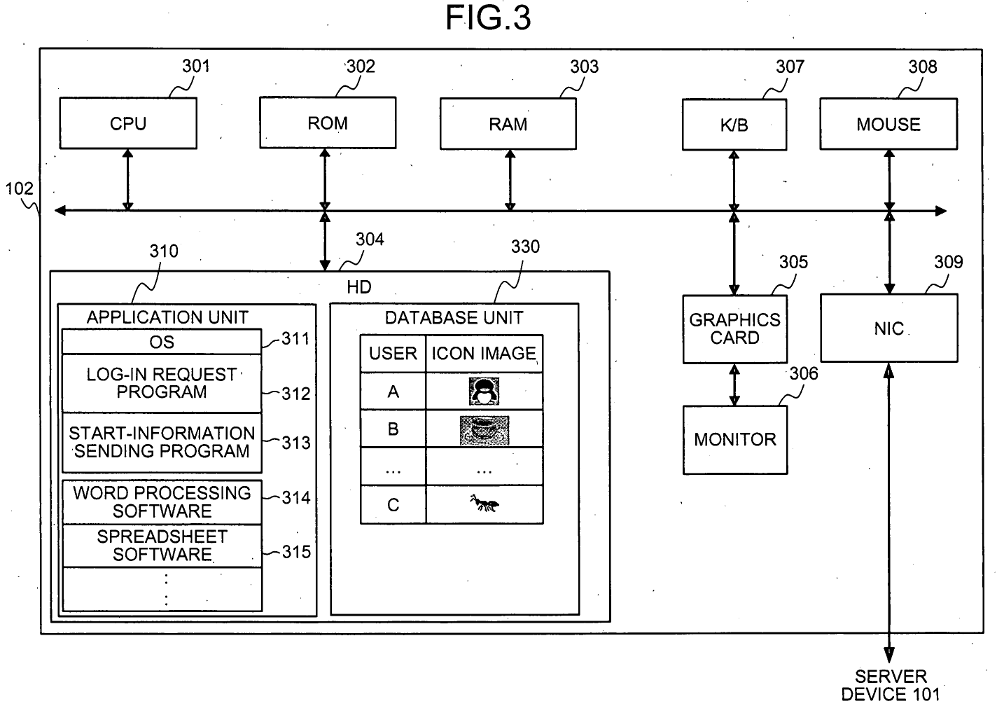

A hardware configuration of the client device 102 will be described below. FIG. 3 is a block diagram of an example of the hardware configuration of the client device 102. The hardware configuration of the client device 102 includes a CPU 301, a ROM 302, a RAM 303, a hard disk (HD) 304, a graphics card 305, a monitor 306, a keyboard (K/B) 307, a mouse (MOUSE) 308, and a network interface card (NIC) 309.

The CPU 301 controls whole the client device 102 together with the OS, and controls processes of various kinds of software, including a log-in process carried out between the CPU 301 and the server device 101. Specifically, for example, the CPU 301 sends information based on the icon image to the server device 101 to perform a procedure for making a log-in request according to a program stored in the hard disk 304 or the ROM 302. The information based on the icon image is the icon image itself or information that is used to extract the start information in the server device 101. The CPU 301 controls drawing for a VRAM of the graphics card 305, and controls to temporarily store, in the RAM 303, work data stored in the hard disk 304.

The ROM 302 stores a boot program and the like. Depending on a use, the ROM 302 may store a control program of the client device 102. The RAM 303 is used as a work area of the CPU 301. More specifically, the RAM 303 temporarily stores various kinds of programs including a log-in processing program read from the hard disk 304 and the start information described above. Depending on a use, the RAM 303 may also store an algorithm for extracting the start information.

The hard disk 304 stores various kinds of software programs (software) such as an operating system (OS), an application program, and a driver. The configuration of the hard disk will be described later.

The graphics card 305 sends an image signal to be output to the monitor 306. The graphics card 305 includes the VRAM that stores the image signal to be output, and an image output interface (I/F) that outputs the image signal processed to the monitor 306. The image output I/F outputs RGB image data loaded into the VRAM to the monitor 306.

The NIC 309 connects the client device 102 to the intranet. In other words, the NIC 309 controls various kinds of communications at a time of connecting the client device 102 to the server device 101 or another client device. The information based on the icon image is output to the server device 101 through the NIC 309, to which a notice of log-in permission is input.

The client device 102 may also includes a flexible disk driver, a CD-ROM driver, an MO driver, and the like.

The hard disk 304 includes an application unit 310 and a database unit 320. The application unit 310 includes an OS 311 that controls an entire operation of the client device 102, a log-in request program 312 that makes a log-in request to the server device 101, and a start-information sending program 313 that sends the information based on the icon image. The application unit 310 further stores word processing software 314, spreadsheet software 315, and various other kinds of software.

The database unit 320 stores the icon image that corresponds to each of the users, and in which the start information is embedded. The client device 102 sends the information based on the icon image to the server device 101 under control of the start-information sending program 313 when the icon image is superimposed on a window displayed on the monitor 306 under control of the log-in request program 312. Although it is shown in FIG. 3 that the icon images for more than one of the users are stored, it is desirable to arrange one icon each for each the client devices 102 to prevent so-called “spoofing”.

(Functional Configuration of Computer System)

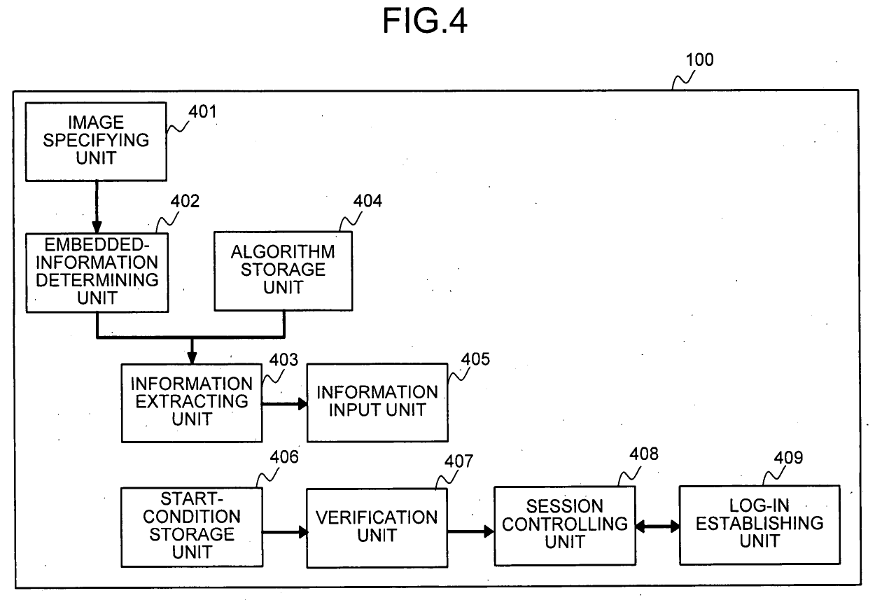

A functional configuration of the computer system 100 will be described below. FIG. 4 is a block diagram of an example of the functional configuration of the computer system 100. The functional configuration of the computer system 100 includes an image specifying unit 401, an embedded-information determining unit 402, an information extracting unit 403, an algorithm storage unit 404, an information input unit 405, a start-condition storage unit 406, a verification unit 407, a session controlling unit 408, and a log-in establishing unit 409.

The image specifying unit 401 specifies the icon image that corresponds to each of the users. The icon image can be specified by clicking or double-clicking on the icon image, or by dragging the icon image and superimposing the icon image on the window that is displayed on the monitor 306 by the start-information sending program 313. When the monitor 306 is a touch panel, the icon image can be specified by touching the touch panel at a position that corresponds to the icon image. The function of the image specifying unit 401 can be implemented, for example, by the mouse 308, the OS 311, the NIC 309, and the start-information sending program 313.

The embedded-information determining unit 402 determines whether the start information necessary for initiating a log-in session is embedded in the icon image specified by the image specifying unit 401. In other words, the embedded-information determining unit 402 determines whether a user ID and a password the icon image are embedded in the icon image. A method for determining whether the start information is embedded in the icon image is not particularly limited. For example, a method of determining based on gradation information on pixels of the icon image at positions (0, 0), (32, 0), (0, 32), and (32, 32) may be employed. The function of the embedded-information determining unit 402 can be implemented, for example, by the log-in authentication program 212, the login request program 312, the start-information sending program 313, the database unit 320, the NIC 209, and the NIC 309.

Depending of a use, the embedded-information determining unit 402 may be functionally integrated with the client device 102 or the server device 101.

When the embedded-information determining unit 402 determines that the start information is embedded in the icon image, the information extracting unit 403 extracts the start information (a user ID and a password) from the icon image according to an algorithm that uniquely corresponds to the user. Since the algorithm that uniquely corresponds to the user is used, the icon image can be used as a cipher that is essentially indecipherable. Moreover, since the icon image is image information, there is an advantage in which it is less likely to be realized that the information such as the user ID and the password are embedded in the icon image, even if the icon image leaks out of the computer system 100. The function of the information extracting unit 403 can be implemented, for example, by the login authentication program 212, the start-information restoration program 213, the database unit 220, the login request program 312, the start-information sending program 313, and the database unit 320. The embedded-information determining unit 402 and the information extracting unit 403 may also be integrated to determine whether the information extracted by the information extracting unit 403 contains the start information.

The algorithm storage unit 404 stores the algorithm that is used in the information extracting unit 403. A as long as the algorithm uniquely corresponds to each of the users, any kind of algorithm may be used, and such an algorithm as mentioned below can be used. For example, when one pixel of the icon image is one byte, it is possible to use an algorithm that restores an American standard code for information interchange (ASCII) code of one byte by combining eight pixels of the least significant bit of the process system, and associates a combining sequence of the eight pixels and an extracting sequence of the numbers of characters that form the user ID and the password according to a structure of the icon image. Therefore, the algorithm in the database unit 220 is a concept that contains information that is used for such restoration. The function of the algorithm storage unit 404 can be implemented, for example, by the start-information restoration program 213 and the database unit 220.

The information input unit 405 inputs, while a log-in process is being executed, the start information extracted by the information extracting unit 403. The verification unit 407 verifies whether the start information input to the information input unit 405 meets the condition for starting the log-in to the server device 101 from the client device 102. The start-condition storage unit 406 stores the condition to permit the log-in. The function of the information input unit 405 can be implemented, for example, by the OS 211, the login authentication program 212, the NIC 209, the NIC 309, and the start-information sending program 313. The function of the verification unit 407 can be implemented, for example, by the login authentication program 212 and the database unit 220. The function of the start-condition storage unit 406 can be implemented, for example, by the database unit 220, and the OS 211.

When the verification unit 407 verifies that the start information meets the condition, the session controlling unit 408 continues with the log-in process and completes the log-in to establish connections between the server device 101 and the client device 102. On the other hand, when the verification unit 407 determines that the start information does not meet the condition, the session controlling unit 408 controls to display that the log-in has failed on the monitor 306 of the client device 102. The login establishing unit 409 establishes connections between the server device 101 and the client device 102 under control of the session controlling unit 408. The function of the session controlling unit 408 can be implemented, for example, by the OS 211, the login authentication program 212, the OS 311, the login request program 312, and the monitor 306. The function of the login establishing unit 409 can be implemented, for example, by the OS 211 and the OS 311.

(Flow of Process by Computer System 100)

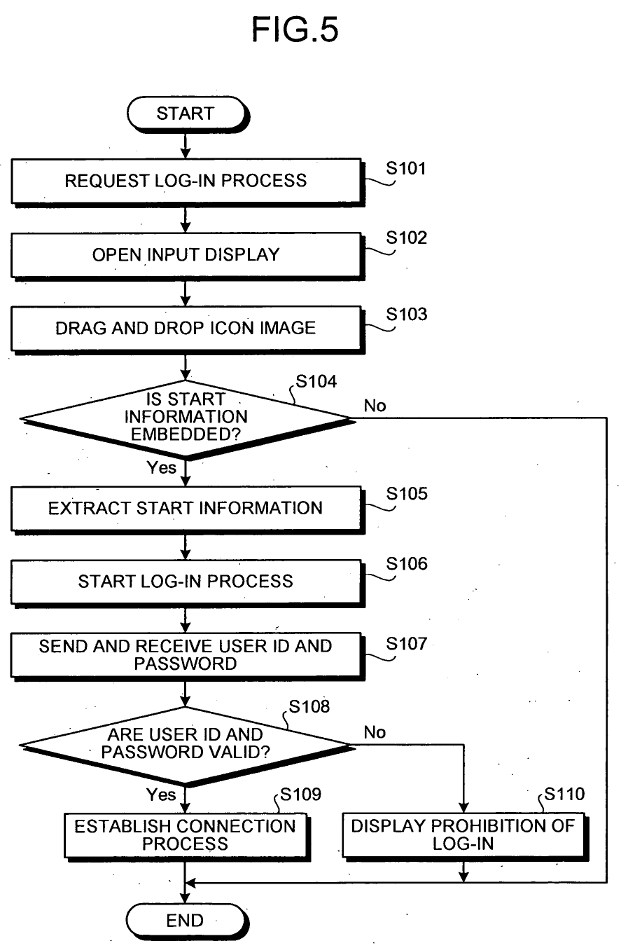

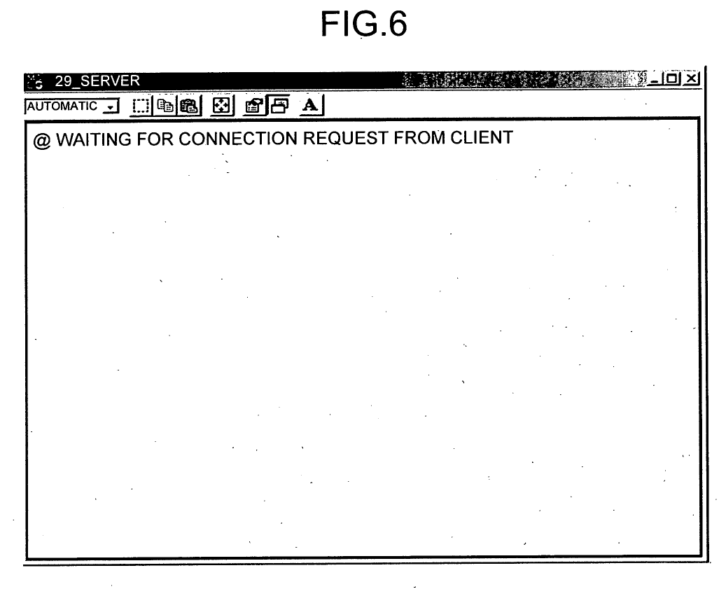

A flow of a process by the computer system 100 will be explained while exemplifying displays that is transitional. FIG. 5 is a flowchart of an example of the process by the computer system 100. The client device 102 requests a process for the log-in to the server device 101 (S101). FIG. 6 is a schematic of an example of a display to request for the log-in process. As shown, a prompt “WAITING FOR CONNECTION REQUEST FROM CLIENT” that indicates a state of the server device is displayed.

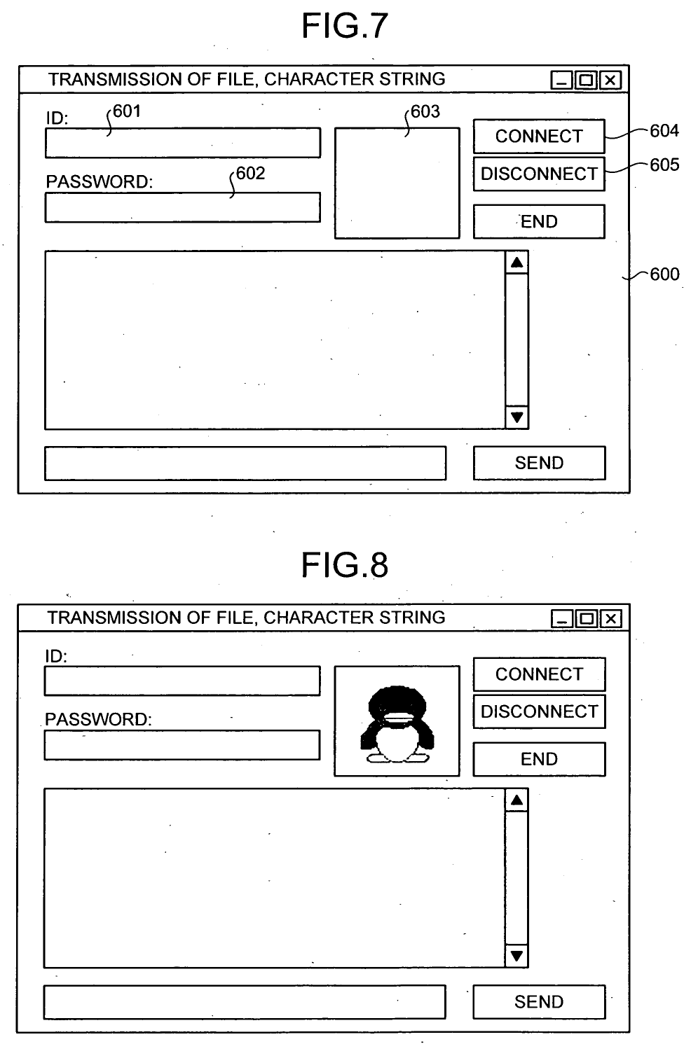

Then, a display for inputting the user ID and the password is opened (step S102). FIG. 7 is a schematic of an example of the display for inputting the user ID and the password on the client device 102. As shown, an input window 600 includes an ID input box 601 into which the user ID is input in a text form, a password input box 602 into which the password is input, and an icon input box 603 onto which the icon image, in which the user ID and the password are embedded, is dragged and dropped. The input window 600 further includes a connect button 604 for making a connection request to the server device 101, and a disconnect button 605 for making a disconnection request.

After the input window 600 is displayed, the user drags and drops the icon image on the icon input box 603 (step S103). FIG. 8 is a schematic of an example of a display that is displayed on the screen when drag and drop of the icon image is just carried out. As shown, the icon image is dropped on the icon input box 603. The icon image may be stored in an appropriate location such as on a desktop and in a predetermined folder. Although in this example, the ID input box 601 and the password input box 602 are not used, these input boxes may be used for connection to the server device 101 as in a conventional practice.

The computer system 100 then determines whether the start information necessary for initiating a predetermined session (step S104) is embedded in the icon image. This determination may be performed either in the client device 102 or the server device 101. When it is determined that the start information is embedded in the icon image (step S104: Yes), the start information is extracted from the icon image according to an algorithm, which uniquely corresponds to the user (step S105). When it is determined that no start information is embedded in the icon image (step S104; No), the process is terminated.

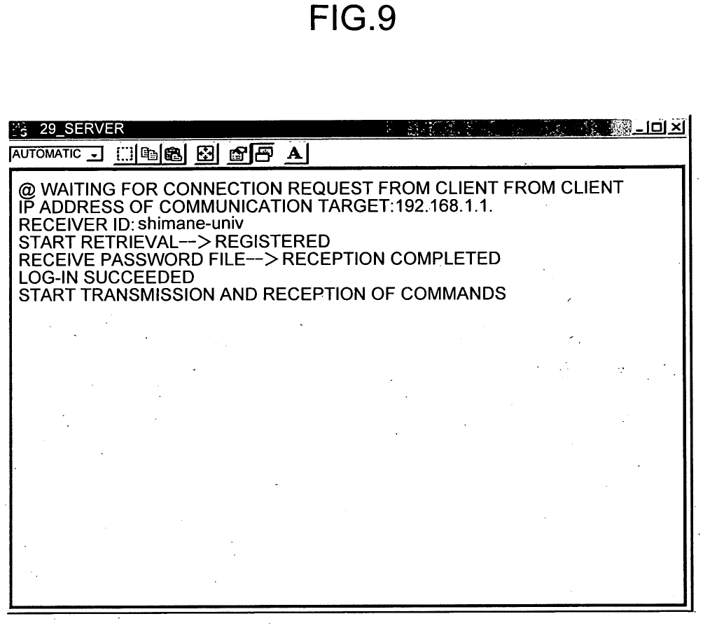

Then, the connect button 604 is pressed to start the log-in process (step S106). During this process, the user ID and the password are input to the server device 101 (step S107). It is then determined whether the input start information meets the condition for the log-in process, that is, the condition for connecting the client device 102 to the server device 101 (step S108). When it is determined that the start information meets the condition (step S108: Yes), the log-in process is continued to establish connection between the client device and the server device (step S109), whereas when it is determined that the start information does not meet the condition (step S108: No), a display that indicates that the log-in is prohibited is displayed on the monitor 306 of the client device 102 (step S110). FIG. 9 is a schematic of a display that is displayed on the monitor 306 of the client device 102 when the log-in is established. As shown, it is displayed that the connection is established. Once the log-in is established, it is possible for the user to manipulate a file store in the server device 101 from the client device 102, or make an application in the server device 101 execute from the client device 102.

As described above, according to the session initiating method, a session can be initiated by manipulating an icon that includes start information that is set for each of users, and that is practically indecipherable. Therefore, the user is relieved of inputting complicated start information that is formed with characters. Furthermore, a system administrator can manage a system without letting the user recognize the start information.

While in the first embodiment, a case in which the present invention is applied to the log-in process has been explained, it is not limited specifically to the case, and the present invention may be applied to a process to start an application. Moreover, while in the first embodiment, a case in which a computer system in an intranet has been explained, it is not limited specifically to the case, and the session initiating method is also applicable on the Internet. For example, the session initiating method is applicable to process for connection to a provider or for authentication process in Internet banking.

While in the first embodiment, the client device and the server device are arranged separately, the invention is not limited this arrangement and one unit of a computer may be shared by a plurality of the users. While in the first embodiment, the server device and the client device have a configuration similar to what is called a PC/AT (personal computer/advanced technologies) machine, it is not limited specifically to this configuration, and may be a personal digital assistant (PDA) or a computer included in a home electric appliance. As one possible example in application, a display screen of a microwave oven is formed as a touch panel, on which an icon for the aged and an icon for a child are provided individually for heating up even in a same way.

### Second Embodiment

In a second embodiment, an icon-image creating apparatus that creates an icon image that is used to initiate a session in a session initiating method according to the present invention will be explained.

(Hardware Configuration of Icon-Image Creating Apparatus)

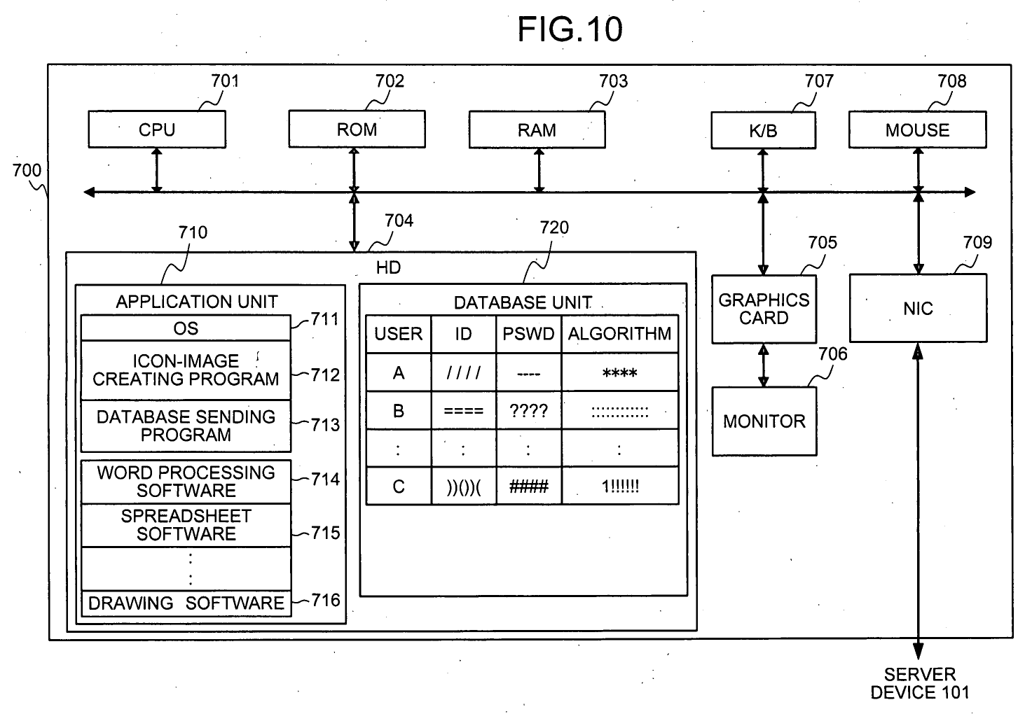

The hardware configuration of the icon-image creating apparatus will be explained. FIG. 10 is a block diagram of an example of the hardware configuration of the icon-image creating apparatus. The hardware configuration of an icon-image creating apparatus 700 includes a CPU 701, a ROM 702, a RAM 703, a hard disk (HD) 704, a graphics card 705, a monitor 706, a keyboard (K/B) 707, a mouse (MOUSE) 708, and a network interface card (NIC) 709.

The CPU 701 controls an entire operation of the icon-image creating apparatus 700 together with an OS, and also controls process for creating an icon image that is necessary for initiating a session. While in the present embodiment, the session is described as a log-in process, the session is not limited specifically to this process, and may also be a process for various kinds of software or a process that constitutes one of functions of the software (for example, activation processing, execution processing, communication processing, authentication processing, connection processing). The CPU 701 also controls drawing for a VRAM of the graphics card 705, or controls to temporarily store, in the RAM 703, work data stored in the hard disk 704.

The ROM 702 stores a boot program and the like. Depending on a use, the ROM 702 may store a control program of the icon-image creating apparatus 700. The RAM 703 is used as a work area of the CPU 701. More specifically, the RAM 703 temporarily stores various kinds of programs including an icon-image creating program read from the hard disk 704 and user information that is assigned to each of the user. The user information is information necessary for properly establishing the log-in process, and that includes the user ID and the password embedded in the icon image corresponding to each of the user.

The hard disk 704 stores various kinds of software programs (software) such as an operating system (OS), an application program, and a driver. The hard disk configuration will be described later.

The graphics card 705 sends an image signal to be output to the monitor 706. The graphics card 705 includes a VRAM that sotres the image signal to be output, and an image output interface (image output I/F) that outputs the image signal processed to the monitor 706. The image output I/F outputs RGB image data loaded into a VRAM to the monitor 706.

The NIC 709 connects the icon-image creating apparatus 700 to a network. The network is not limited to any particular kind, and may preferably be one that is controlled to prevent leakage of icon images other than a target icon image.

The icon-image creating apparatus 700 may includes a flexible disk driver, a CD-ROM driver, an MO driver, and the like.

The hard disk 704 includes an application unit 710 and a database unit 720. The application unit 710 includes an OS 711 that controls an overall operation of the icon-image creating apparatus 700, an icon-image creating program 712 for creating an icon image, and a database sending program 713 for sending the icon image created to the server device 101. The application unit 710 further stores various kinds of software such as word processing software 714, spreadsheet software 715, and drawing software 716.

The database unit 720 stores a triad of the user ID, the password, and the algorithm for each of the user. The algorithm is uniquely corresponds to each of the user, and that is to determine in which areas and in what order the user ID and the password should be embedded in the icon image. Therefore, even if an ill-intentioned third party realizes that the user information is embedded in the icon image, the user information cannot be restored without knowing the algorithm, and this enables to construct a system with high security.

(Functional Configuration of Icon-Image Creating Apparatus)

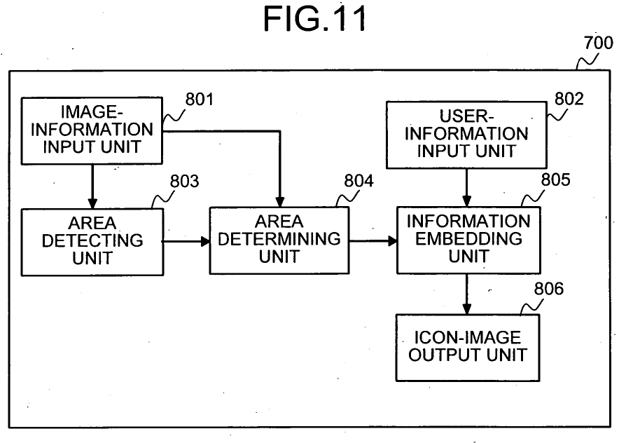

A functional configuration of the icon-image creating apparatus 700 will be described below. FIG. 11 is a block diagram of an example of the functional configuration of the icon-image creating apparatus 700. The functional configuration of the icon-image creating apparatus 700 includes an image-information input unit 801, a user-information input unit 802, an area detecting unit 803, an area determining unit 804, an information embedding unit 805, and an icon-image output unit 806.

The image-information input unit 801 inputs icon image information that corresponds to each of the user. The icon image can be of any kind as long as it is used in the computer system exemplified in the first embodiment. For example, with Windows (an operating system by Microsoft Corporation), it is possible to use an image of 32 by 32 pixels that is normally displayed on a desktop screen. In order for the user to readily identify the icon exclusive to the user, it is possible to use a bitmap-format image created by the user or an icon image converted from a photograph of the user's face taken by a digital still camera. A function of the image-information input unit 801 can be implemented, for example, by the mouse 708, the K/B 307, the OS 311, and the icon-image creating program 712.

The user-information input unit 802 inputs user information that corresponds to each of the user. In the present embodiment, the user information is, specifically, the user ID and the password for the log-in process. Depending on a use, other information, for example, a name of a station or group to which the user belongs, or an Internet Protocol (IP) address of the computer being used, may also be included in the user information. A function of the user-information input unit 802 can be implemented, for example, by the database unit 720, the OS 711, and the icon-image creating program 712.

The area detecting unit 803 detects an area for embedding additional information without altering the icon image according to the structure of the icon image information. The term, “without altering the icon image” means to prevent the icon from undergoing a substantial change in appearance after the additional information is embedded. This means that, for example, when the icon image is a photograph of the user's face, it must be free from darkening of complexion, showing-up of moles, or a change in profiles. It is also necessary that a continuous gradation of color is not considerably damaged. However, it is only necessary to keep the icon image look substantially same in appearance, such changes that can be found only when the icon images before and after embedding the additional information are closely compared are permissible.

The additional information does not always mean an increase in the amount of information, and includes embedding or rewriting of information.

The area for embedding the additional information may be an image area or a frequency area. For example, pixels, which do not change the appearance of the icon image in its entirety even if information for determining pixel gradation is slightly changed, provide an area for embedding the additional information. Specifically, if the pixels are expressed with a 256-gradation, the additional information can be written using a plurality of the least significant bits of the process system. A function of the area detecting unit 803 can be implemented, for example, by the icon-image creating program 712, the OS 711, and the drawing software 716.

The area determining unit 804 determines the area for embedding the user information input by the user-information input unit 802 from the areas detected by the area detecting unit 803, according to an algorithm that uniquely corresponds to the user. For example, when the user ID is formed with eight alphabetic characters, information of 8 bytes=64 bits is required, and the area determining unit 804 determines the areas by uniquely associating 64 places for embedding the information with the user. Various methods can be used to uniquely associate the places for embedding the information with the user. For example, it is possible to use the user ID or the password to be associated with the places. The icon image itself can also be used. The simplest way of association is to embed the information in the areas in order in which the area is detected by the area detecting unit 803, but the method is not limited to this method. Since extraction or restoration of the user ID and the password is impossible without recognition, at the server device, of a type of the algorithm used, the database unit 720 stores the user ID, the password, and the algorithm (or a clue to the algorithm), corresponding to each of the user. A function of the area determining unit 804 can be implemented, for example, by the OS 711, the icon-image creating program 712, the drawing software 716, and the database unit 720.

The information embedding unit 805 embeds the user information in the areas determined by the area determining unit 804. The mode of embedding the information also includes rewriting predetermined 0, 1 signals. A function of the information embedding unit 805 can be implemented, for example, by the OS 711, the icon-image creating program 712, and the drawing software 716.

The icon-image output unit 806 outputs the icon image in which the user information is embedded by the information embedding unit 805. The icon image may be output to the HD 704 or the client device 102 in the first embodiment. For the log-in process by the server device 101, it is necessary that the user ID and the password and the algorithm, by which the user ID and the password are embedded, are recognized in the server device 10. Therefore, the icon-image creating apparatus 700 needs to transfer a set of the user ID, the password, and the algorithm, which are stored in the database unit 720, to the server device 101. The set may be transferred by the icon-image output unit 806. The icon-image creating apparatus 700 may be the server device 101 itself. In this case, an output process of the icon-image output unit 806 is writing the icon image to the hard disk. A function of the icon-image output unit 806 can be implemented, for example, by the OS 711, the database sending program 713, and the database unit 720.

(Flow of Process by Icon-image Creating Apparatus)

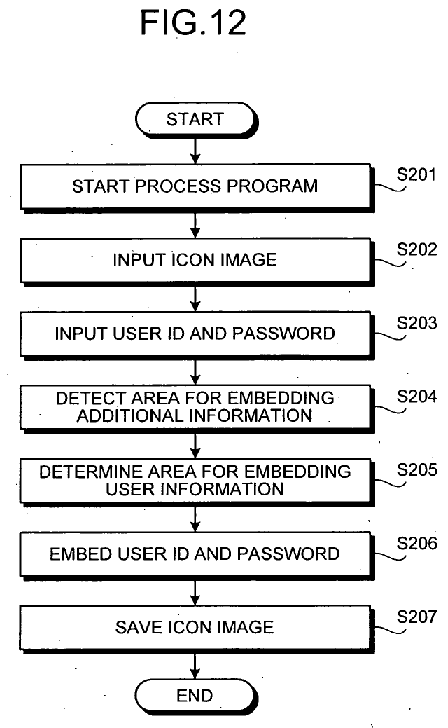

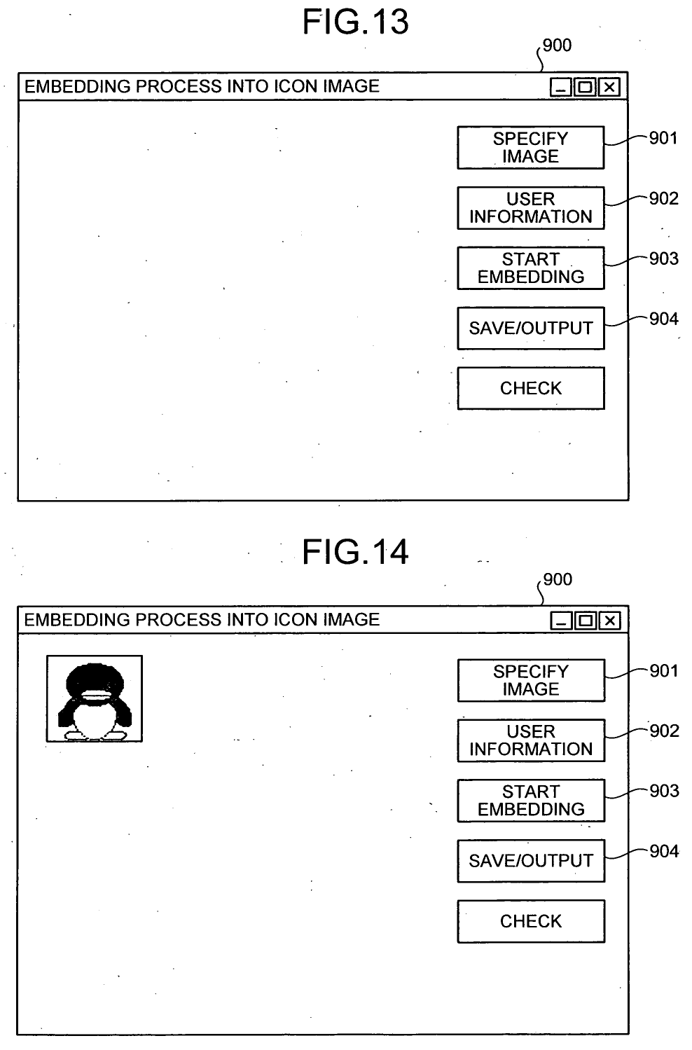

A flow of a process by the icon-image creating apparatus 700 will be explained while exemplifying displays that is transitional. FIG. 12 a flowchart of an example of a process by the-icon-image creating apparatus 700. A process program for embedding the user information in the icon is started (step S201). FIG. 13 is a schematic of an example of a display that is displayed when the process program is just started. As shown, the process window 900 has an icon specifying button 901 for specifying the icon image, a user information button 902 that is pressed to input the user information, an embedding button 903 for starting a process for embedding the user information in the icon image, and a save button 904 for saving the icon image. The window 900 also includes a check button for checking whether the user information has been embedded.

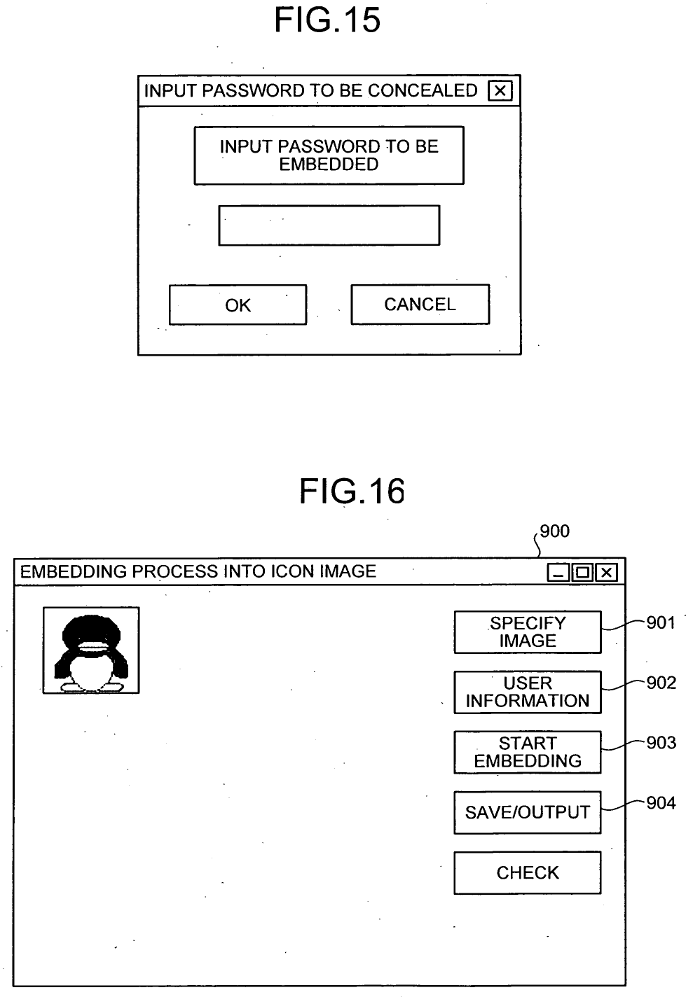

The specifying button 901 is pressed by the user to specify the icon image. Thus, the icon image is input (step S202). FIG. 14 is a diagram of an example of a display that is displayed after the icon image is specified. As shown, an icon that has an image of a penguin is specified here. The user information button 902 is then pressed by the user to input the user ID and the password (step S203). FIG. 15 is a schematic of an example of a window display that instructs to input the password. The user or an administrator inputs the password in this box.

Areas into which the additional information can be embedded are detected according to a structure the icon image (step S204). The areas in which the user ID and the password are to be embedded are determined from among the detected areas according to the algorithm, which uniquely corresponds to the user (step S205). For example, when one pixel of an icon image with 32 by 32 pixels is expressed with a 256-gradation of RGB and the user information is embedded in any one bit of the gradation, there is a total of 32×32×3=3072 areas in which the user information can be embedded.

The user ID and the password are then embedded in the areas determined at step S205 (step S206), which is carried out by pressing the embedding button 903. FIG. 16 is a schematic of the window 900 that is displayed after an embedding process is performed. As shown, no noticeable difference is found between the icon images of penguin before and after the embedding process (see FIG. 14). The icon image processed is then saved (step S207). Thus, the icon image in which the user information is embedded is output to and saved in a predetermined location.

While in the above explanation, the icon-image creating apparatus 700 has been described as if the icon-image creating apparatus 700 is a different device independent from the server device 101 or the client device 102 that forms the computer system 100 according to the first embodiment, the icon-image creating apparatus 700 may be the server device 101 or the client device 102 as long as the user information can be embedded in the icon image. In this case, the icon-image output unit 806 can store the icon image in the database unit 220 of the server device 101 or in the database unit 320 of the client device 102. Particularly, if the icon-image creating apparatus 700 is the server device 101, the administrator can manage individual icon images collectively, and the icon image can be distributed without allowing even the user to realize that the user information is embedded in the icon image. Therefore, management efficiency increases.

As described above, according to a session initiating method of the present invention, the session initiating method is applied to a computer system equipped with the GUI, and includes specifying an icon image that corresponds to each of user; determining embedded information to determine whether start information that is necessary for initiating a session that is predetermined is embedded in the icon image specified in the image specifying; extracting the start information from the icon image in accordance with an algorithm that uniquely corresponds to each of the user when it is determined that the start information is embedded in the icon image in the determining; setting up the session; inputting, during the session that is set up in the setting up, the start information extracted in the extracting; verifying whether the start information input in the inputting meets a condition for initiating the session; and controlling the session to initiate the session if it is determined, in the verifying, that the start information meets the condition, and to discontinue setting up the session if it is determined, in the verifying, that the start information does not meet the condition. Therefore the user can be relieved of inputting character-based complicated start information, and the system administrator can manage the system without letting each of the users to recognize the start information, and it is possible to provide a computer system with increased security.

According to a session initiating method of the present invention, because the start information in the session initiating method is information that includes the user ID and the password of the user, it is unnecessary for the user to memorize the user ID and the password to initiate the session. Therefore, the user can be relieved of inputting character-based complicated start information, and the system administrator can manage the system without letting each of the users to recognize the start information, and it is possible to provide a computer system with increased security.

According to an icon-image creating apparatus of the present invention, the icon-image creating apparatus creates an icon image to initiate the session, and includes an image-information inputting unit that inputs icon image information that corresponds to each of users; a user-information inputting unit that inputs user information that is assigned to each of the users; an area detecting unit that detects an area in which additional information can be embedded without altering the icon image, according to a structure of the icon image information input by the image-information inputting unit; an area determining unit that determines the area in which the user information, which is input by the user information inputting unit, is to be embedded, from the areas detected by the area detecting unit, in accordance with an algorithm that uniquely corresponds to each of the users; an information embedding unit that embeds the user information in the area determined by the area determining unit; and an icon-image outputting unit that outputs the icon image in which the user information is embedded by the information embedding unit. Thus, in the icon-image creating apparatus, it is possible to embed user information as an essentially indecipherable cipher in the icon image that is easily identified by the user. Therefore, the user can be relieved of inputting character-based complicated start information, and it is possible to construct a highly convenient computer system.

According to the present invention, in the icon-image creating apparatus, the user information includes a user ID and a password that is necessary for initiating the session. Thus, initiation of the session is possible even if the user does not remember his/her user ID and password. Therefore, the user can be relieved of inputting character-based complicated start information, and it is possible to construct a highly convenient computer system.

A computer program for initiating a session according to the present invention is applied to a computer system equipped with a graphical user interface (GUI), and makes a computer function as an image specifying unit, an embedded-information determining unit, an information extracting unit, a session setting-up unit, an information input unit, a verification unit, and a session controlling unit, and makes the computer execute specifying an icon image that corresponds to each of user; determining embedded information to determine whether start information that is necessary for initiating a session that is predetermined is embedded in the icon image specified in the image specifying; extracting the start information from the icon image in accordance with an algorithm that uniquely corresponds to each of the user when it is determined that the start information is embedded in the icon image in the determining; setting up the session; inputting, during the session that is set up in the setting up, the start information extracted in the extracting; verifying whether the start information input in the inputting meets a condition for initiating the session; and controlling the session to initiate the session if it is determined, in the verifying, that the start information meets the condition, and to discontinue setting up the session if it is determined, in the verifying, that the start information does not meet the condition. Therefore, it possible to initiate the session by manipulating the icon that includes the essentially indecipherable start information set for each of the user. Thus, the user can be relieved of inputting character-based complicated start information, and a system administrator can manage a system without letting the user recognize the start information. It is also possible to provide a computer system with increased security.

A computer program for creating an icon-image to initiate the session according to the present invention makes a computer function as an image-information inputting unit, a user-information inputting unit, an area detecting unit, an area determining unit, an information embedding unit, and makes the computer execute inputting icon image information that corresponds to each of users; inputting user information that is assigned to each of the users; detecting an area in which additional information can be embedded without altering the icon image, according to a structure of the icon image information input by the image-information inputting unit; determining the area in which the user information, which is input by the user information inputting unit, is to be embedded, from the areas detected by the area detecting unit, in accordance with an algorithm that uniquely corresponds to each of the users; embedding the user information in the area determined by the area determining unit; and outputting the icon image in which the user information is embedded by the information embedding unit. Thus, it is possible to embed user information as an essentially indecipherable cipher in the icon image that is easily identified by the user. Therefore, the user can be relieved of inputting character-based complicated start information, and it is possible to construct a highly convenient computer system.

According to the present invention, in the computer program for creating an icon-image, the user information includes a user ID and a password that is necessary for initiating the session, and the initiation of the session is possible even if the user does not remember his/her user ID and password. Therefore, the user can be relieved of inputting character-based complicated start information, and it is possible to construct a highly convenient computer system.

### INDUSTRIAL APPLICABILITY

As described above, the session initiating method, the icon-image creating apparatus, the session initiating program, and the icon-image creating program according to the present invention are applicable to a computer system equipped with a GUI to provide increased security and convenience.

1-8. (canceled)

9. A session initiating method that is applied to a computer system equipped with a graphical user interface, the session initiating method comprising:
specifying an icon image corresponding to a user;
determining whether start information necessary for initiating a session that is predetermined is embedded in the icon image;
extracting the start information from the icon image based on an algorithm that is unique to the user when it is determined that the start information is embedded in the icon image at the determining;
setting-up the session;
inputting the start information extracted at the extracting during the session set up at the setting-up;
verifying whether the start information input at the inputting satisfies a condition for initiating the session; and
controlling the session based on a result of the verifying, wherein,
when it is verified that the start information satisfies the condition, the controlling includes initiating the session, and
when it is not verified that the start information satisfies the condition, the controlling includes aborting the session.

10. The session initiating method according to claim 9, wherein the start information includes an identification and a password of the user.

11. A computer readable recording medium that stores a computer program for initiating a session that is applied to a computer system equipped with a graphical user interface, the computer program making a computer execute:
specifying an icon image corresponding to a user;
determining whether start information necessary for initiating a session that is predetermined is embedded in the icon image;
extracting the start information from the icon image based on an algorithm that is unique to the user when it is determined that the start information is embedded in the icon image at the determining;
setting-up the session;
inputting, during the session set up at the setting up, the start information extracted at the extracting;
verifying whether the start information input at the inputting satisfies a condition for initiating the session; and
controlling the session based on a result of the verifying, wherein,
when it is verified that the start information satisfies the condition, the controlling includes initiating the session, and
when it is not verified that the start information satisfies the condition, the controlling includes aborting the session.

12. The computer readable recording medium according to claim 11, wherein the start information includes an identification and a password of the user.

13. An icon-image creating apparatus that creates an icon image to initiate a session, the icon-image creating apparatus comprising:
an image-information inputting unit that inputs icon image information corresponding to a user;
a user-information inputting unit that inputs user information of the user;
an area detecting unit that detects a first area based on a structure of the icon image information, the first area for embedding additional information without altering the icon image;
an area determining unit that determines a second area, based on an algorithm that is unique to the user, from among the first areas detected, the second area for embedding the user information;
an information embedding unit that embeds the user information in the second area determined; and
an icon-image outputting unit that outputs the icon image with the user information embedded.

14. The icon-image creating apparatus according to claim 13, wherein the user information includes an identification and a password of the user necessary for initiating the session.

15. A computer readable recording medium that stores a computer program for creating an icon-image to initiate a session, the computer program making a computer execute:
inputting icon image information corresponding to a user;
inputting user information of the user;
detecting a first area based on a structure of the icon image information, the first area for embedding additional information without altering the icon image;
determining a second area, based on an algorithm that is unique to the user, from among the first areas detected, the second area for embedding the user information;
embedding the user information in the second area determined; and
outputting the icon image with the user information embedded.

16. The computer readable recording medium according to claim 15, wherein the user information includes an identification and a password of the user necessary for initiating the session.
